(19) United States
(12) Patent Application Publication
(10) Pub. No.: US 2015/0370985 A1
(43) Pub. Date: Dec. 24, 2015

(54) System and Method for Crowdsourcing Biological Specimen Identification

(71) Applicants: JOSEPH R CARVALKO, NORTH PALM BEACH, FL (US); CARA C MORRIS, NORTH PALM BEACH, FL (US)

(72) Inventors: JOSEPH R CARVALKO, NORTH PALM BEACH, FL (US); CARA C MORRIS, NORTH PALM BEACH, FL (US)

(21) Appl. No.: 14/322,006

(22) Filed: Jul. 2, 2014

Related U.S. Application Data
(60) Provisional application No. 62/016,171, filed on Jun. 24, 2014.

(51) Int. Cl. G06F 19/00

(52) U.S. Cl. CPC G06F 19/3425; G06F 19/321

(57) ABSTRACT

A system and method for crowdsourcing medical diagnosis that includes a caregiver taking a biological specimen from a patient, making a microscope slide with the specimen, photographing the image and transmitting it, including personal and demographic information related to the patient, to a remote computer, where the data is stored in a database for crowdsourced analysis, collecting the opinions of the individuals forming the crowdsource, weighting the opinions based upon qualifications of the individuals, and developing a pooled diagnosis based a parameter, such as frequency of a diagnosis occurring in the crowd of individuals, and transmitting the diagnosis to the caregiver, for prescribing medication, a therapy or further medical tests.

### FIELD OF THE INVENTION

This application relates generally to a system and method of crowdsourcing medical diagnosis, for patients in rural areas or developing countries throughout the world, where access to health care is limited.

### BACKGROUND OF THE INVENTION

Technology that has linked people around the world for security, social and economic reasons, has yet to reach its potential for providing solutions to what has been the intractable demand for medical diagnostic resources, especially where people are too impoverished to reap the benefit of modern medicine.

According to UNICEF, malaria affects 350-500 million people each year, killing in Africa upwards of 700,000 million children. Many die because the routine identification of the disease is too costly for small rural villages. Medical diagnosis accounts for about 10 percent of all medical costs, or approximately $250 billion per year in the United States alone. Beyond economic costs the human costs of delayed and/or inaccurate diagnosis are also substantial, in terms of human suffering and death.

Disease can arise from a wide variety of sources and causative agents, including foodborne (e.g., worms, fungi (molds)), parasites (including helminth eggs and larvae), waterborne (e.g., Schistosoma mansoni) and blood-borne (HIV; Plasmodium falciparum), as well as emerging diseases (e.g., Methicillin-resistant Staphylococcus aureus (MRSA)). These maladies can be identified by their morphological characteristics using differential staining techniques such as gram staining or acid fast staining and aided by a light microscope. Leukocyte or white blood cell counting based on morphology, employs Wright's stain or Giemsa stain, and constitutes one of the most important uses of the microscope in diagnostic medicine. Other cytological dysfunction or the identity of microbial invasions into red or white blood cells can, and often is, a vital step in the diagnosis of disease, such as sickle cell anemia and leukemia.

Although alternatives to microscopy may exist for certain disease detection, they prove costly. A case in point: a malaria test kit exists; and when cost is the driving factor, it is a less costly option over microscopy. But, developing countries can rarely afford either the expense of outfitting rural communities with microscopes or with malaria test kits. Overall microscopes are more versatile than kits for specific detection of disease, and remain the gold standard test for the diagnosis of malaria. This is true for a large number of diseases.

The common white blood cell differential count (WBDC) can be achieved through conventional microscopy, although most laboratories in developed nations employ automatic electronic counters. Automated counters are prohibitively expensive, costing in the thousands of dollars. Therefore, conventional microscopy for WBDC, until now, offers the only practical instrumentation for rural clinics. The process of mounting a biological sample and applying the correct stain can be accomplished by trained, but nonetheless relatively unskilled, health workers. However, accurately identifying the biological specimen requires significant training, which in most cases is not available in underdeveloped communities.

Part of the problem in diagnostic medicine has been the shortage of trained medical professionals and the further lack of medical equipment required by health workers in remote areas. Microscopes are a mainstay of any medical laboratory, but often the cost of owning one, for example in a small rural village is prohibitive. However, recent developments in a paper based origami-like microscope, the size of a bookmark and virtually indestructible, will become widely available at costs of under one-dollar to produce. One product is now promoted under the trademark Foldscope (Foldscope is a trademark of The Board of Trustees of the Leland Stanford Junior University AKA Stanford University) and is a print-and-fold optical microscope that can be assembled from a flat sheet of paper. It reportedly can provide over 2,000× magnification with sub-micron resolution (800 nm), weighing less than 8.8 g, and is small enough to fit in a pocket (70×20×2 mm). Its scalable design is application-specific instead of general-purpose, which makes it suitable for applications in global health and field based citizen science.

Microscopes alone do not solve the problem of diagnosing patient illnesses in communities that are too poor to employ doctors or clinicians with pathology backgrounds. Therefore a link to where others might assist in diagnosis would help, provided there were enough of these resources, available in a timely fashion.

Smartphones are a way of communicating over long distances, not only voice communication, but by image and text information, which are essential for a remote medical diagnostic system, i.e., one which not only had access to the image of the disease, but also information on the patient. Most smartphones can be outfitted with a lens that would permit photographing a microscope image the Foldscope-type microscope can generate. Alternatively, a special lens can turn a smartphone, such as an iPhone or Android camera phone, into a portable handheld microscope (current minimum camera requirements are 5 megapixels). One such devices claims a soft lens that sticks directly onto the camera lens on the back of the phone and allows a user to zoom into 15× magnification (shortly 150× lens will become available). In the research stage are fluorescent microscopes that use a physical attachment to an ordinary cell phone, which will identify and track diseases, such as tuberculosis and malaria.

Zziwa, U.S. Pat. Application 20130253940 discloses collecting and storing electronic data from a search user seeking to obtain diagnosis, applying stored diagnosis rules to the electronic data to identify possible diagnoses each having an associated diagnosis rule trust factor and based on information received from expert users and non-preselected contributing users, and communicating multiple possible diagnoses based at least in part on diagnosis rule trust factors. The storing of explicit rules in respect to rendering a diagnosis, as taught by Zziwa, is an unnecessary step for the identification of biological specimens, in part because classification depends on a complicated mix of morphology, color, texture, and other cytological features that make it difficult and cumbersome to use a rule set in identification. The identification of biological specimens is an art learned through education, training and experience.

In the prior art to date, a trust factor regarding the diagnosing individual is discussed. Zziwa uses trust factors: eliciting feedback from the search user (presumably the individual who is searching for a cure or its health care worker) seeking to obtain diagnosis of the condition or problem, wherein feedback is indicative of accuracy of the at least one possible diagnosis; and adjusting at least one rule trust factor based on feedback from the user; updating the expert user trust factor based upon receipt of ratings of the expert user, generated by search users seeking diagnosis of conditions or problems. In Zziwa, the process uses experts, who have assigned to them a trust factor, which in turn depends on the opinions of the users of the system, which in many cases might be an unreliable indicator of whether a particular diagnosis led to a medically positive outcome. There is a need for a user independent assessment of whether the individual tendering the diagnosis conforms to the diagnosis of his or her peers.

Halterman U.S. Pat. Application 20120245952 also discloses a trust system using in one embodiment the weighting of variables includes assigning different weights to diagnostic responses received from personnel, versus a suggested diagnosis, therapy, inquiry to aid in establishing a diagnosis, or a medical test identified in a medical reference. The resulting output using the differing weights, can be the probability of producing a given answer, and can be ranked with more heavily weighted responses displaying more prominently in the results presented to the indexed user (e.g., ranking responses form trusted colleagues more heavily than responses from colleagues unfamiliar to the user). In Halterman the trusted expert enhances credibility, but not based upon his or her peers who are operating under the same set of medical information.

Marins, et al, U.S. Pat. Application 20120284090 also assigns a trust score to each of the plurality of participating users, the trust score being based on completion of the one or more crowd sourcing activities to indicate a level of trust earned by a participating user relating to the veracity of the completion of the one or more crowd sourcing activities. What is needed is the establishment of credibility based on how one performs the same examination of a biological specimen measured against a majority of crowdsource volunteer peers, not solely on the completion of the crowd sourcing activities.

Overall what is needed is a technology that can provide the solutions to the intractable problem of the unmet demand for the identification of biological specimens, by using help with wide ranging skills and experiences in assisting in the identification of diseases that are revealed through microscopy. Further, the full advantages of autonomous crowdsourcing diagnoses can be achieved, if a majority of the individuals rendering a diagnosis are regarded as the peer group standard, against which each of the individuals rendering a diagnosis are judged as to competency.

One such resource as disclosed below is crowdsourcing medical diagnosis, such that a caregiver may transmit data, including an image of bodily specimen, to a remote computer, where the data can be stored in a database for analysis of the patient's condition, by a population of crowdsource volunteers having disparate expertise (such as highly skilled pathologists, to college biology students, to nurses and ex-service personnel that may have served in the medic corps), collecting the opinions of the crowdsource volunteers and weighting the opinions based upon weighted qualifications (based on the proximity of their diagnosis to the mean peer diagnosis), forming a diagnosis based on a statistical parameter, such as frequency of a diagnosis (mean peer diagnosis) occurring among the crowdsource volunteers, and then transmitting the identification of the specimen or a diagnosis to the caregiver, wherein the caregiver may prescribe a drug, therapy and a medical test. The present invention solves each of these problems in an integrated system that has a commercial application due to its accessibility by health care workers from around the world, as well as its accuracy, reliability, safety and low cost.

### SUMMARY OF THE INVENTION

This invention provides for a computer-implemented method for crowdsourcing a medical diagnosis comprising the steps of: forming an image from a microscope slide containing a bodily specimen of a patient, transmitting to a remote computer data including, the image and information related to the patient, storing the data, forming a population of crowdsource volunteers for an identification of the specimen, collecting an opinion of the identification of the bodily specimen from one or more crowdsource volunteers, calculating a qualification weight for each of the crowdsource volunteers, based on each crowdsource volunteer identification of a prior specimen, calculating a weighted frequency of the identification of the specimen by applying the qualification weight to each crowdsource volunteer identification of the specimen, determining a diagnosis based on one of weighted frequency of (a) a maximum occurrence, (b) a median occurrence or (c) a mode occurrence of the identification of the specimen, transmitting the identification of the specimen to the caregiver, wherein the caregiver may prescribe one of a prescription drug, a therapy or a medical test.

The method further includes that the qualification of a crowdsource volunteer, include one or more of their education, training, experience, years in the field of the biological or medical arts and the number of times the individual selects a diagnosis that falls into the category of the most frequently occurring diagnosis within a category of other candidate diagnoses.

This invention further provides for non-transitory computer readable medium having program code stored thereon, the program code being executable by a processor to cause the processor to perform operations comprising: transmitting a bodily specimen microscope image from a patient, transmitting information related to the patient from a caregiver, to a remote computer, storing the data in a database, forming a population of a plurality of crowdsource volunteers, collecting the opinions of the crowdsource volunteers about an identification of the specimen, and weighting the saliency of the identification of the specimen based upon a crowdsource volunteer qualification, storing the identification of the specimen according to one or more categories of like images, forming a probable diagnosis based on a maximum occurrence within one of the categories of like images, transmitting the diagnosis to the caregiver, wherein the caregiver may prescribe a drug, therapy or a medical test.

This invention also provides for a system for crowdsourcing a medical diagnosis including the: a microscope for forming an optical image of a bodily specimen from a microscope slide, a digital acquisition device, such as a smartphone for electronically capturing the optical image of the bodily specimen, a communication system for transmitting to a remote computer, data including, the electronic image and text information related to the patient, a computer storage device for storing the data, a computer system and software for connecting a population of crowdsource volunteers for an identification of the specimen, a computer processor for: collecting an opinion of the identification of the bodily specimen from one or more crowdsource volunteers, calculating a qualification weight for each of the crowdsource volunteers, based on each crowdsource volunteer identification of a prior specimen, calculating a weighted frequency of the identification of the specimen by applying the qualification weight to each crowdsource volunteer identification of the specimen, determining a diagnosis based on one of a maximum occurrence weighted frequency or a median occurrence of the identification of the specimen, transmitting the identification of the specimen to the caregiver.

### BRIEF DESCRIPTION OF THE DRAWINGS

This invention is best understood from the following detailed description when read in connection with the accompanying drawing. The various features of the drawing are not specified exhaustively. On the contrary, the various features may be arbitrarily expanded or reduced for clarity. Included in the drawing are the following figures and equations:

FIG. 1 is a block diagram of a system for crowdsourcing medical diagnosis in accordance with one embodiment of the present invention.

FIG. 2 is a flow chart of a method for crowdsourcing medical diagnosis in accordance with one embodiment of the present invention.

FIG. 3 is a flow chart of crowdsourcing medical diagnosis credentialing in accordance with one embodiment of the present invention

FIG. 4 is a flow chart of crowdsourcing medical diagnosis credentialing in accordance with one embodiment of the present invention.

FIG. 5 is a flow chart of crowdsourcing medical diagnosis credentialing in accordance with one embodiment of the present invention.

### DETAILED DESCRIPTION OF THE INVENTION

In the figures to be discussed, the circuits and associated blocks and arrows represent functions of the process according to the present invention, which may be implemented as electrical circuits and associated wires or data busses, which transport electrical signals. Alternatively, one or more associated arrows may represent communication (e.g., data flow) between software routines, particularly when the present process or apparatus of the present invention is a digital process. The invention described herein utilizes electronic processors, such as computers, defined as and represented by smartphones, tablets, and computer servers, locally and remote, having computer processors, memories and data storage means, to process data and perform logical functions and mathematical computations using algorithms for accomplishing the stated goal: diagnosis of a medical conditions based upon crowdsourced participation of medical and non-medically trained individuals.

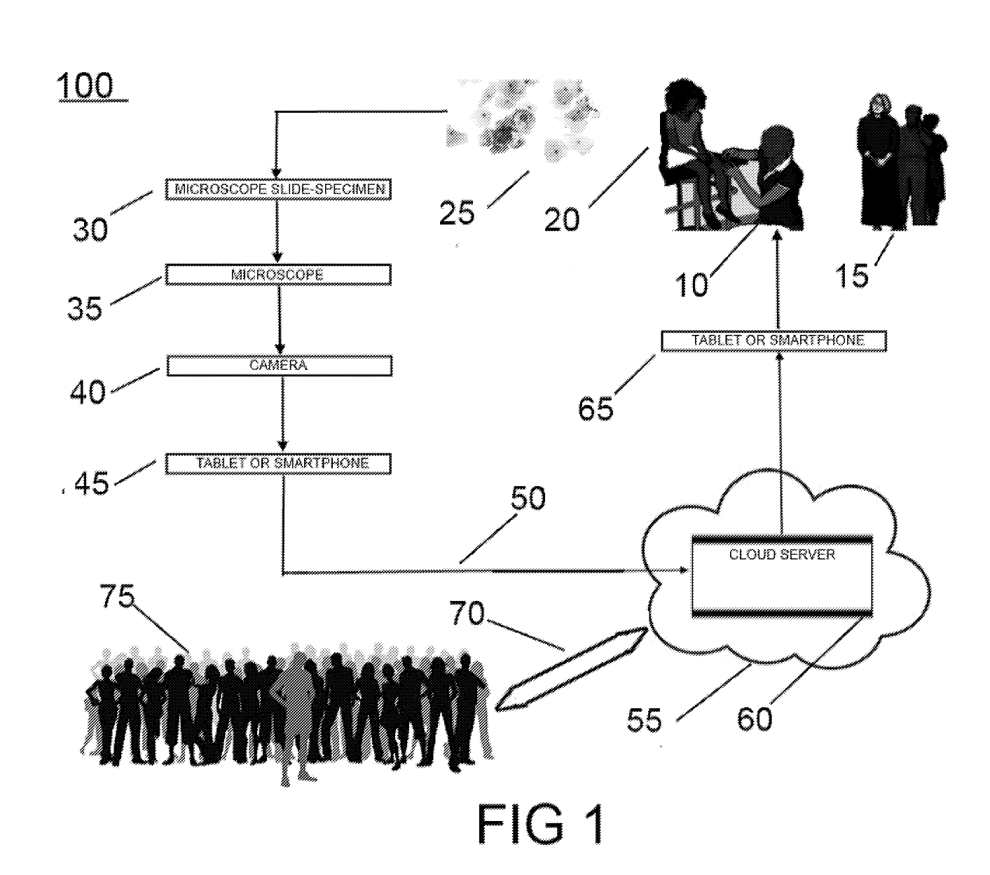

FIG. 1 shows a system 100 for crowdsourcing medical diagnosis that includes a caregiver 10 transmitting data including an image of bodily specimen 25 as well as personal and demographic information (collectively “Data”) related to the patient 20, of a group of patients 15, to a remote computer 60, wherein the Data is stored in a database for the (a) identification of the specimen and optionally its salient attributes or (b) a analysis of the health status, such as a diagnosis of a specific disease, family of disease or clinical condition. The foregoing (a) and (b) are herein collectively referred to as the “diagnosis” as related to the patient 20. A clinical condition is the one having been diagnosed by whatever means called for (example: using biological specimen identification). The diagnosis is determined by crowdsource volunteers 75 having disparate expertise that employ system 100 for collecting their collective opinions via an Internet connection 70 and weighting their diagnostic opinions, based upon their qualifications, converting the opinions into a numerical result, and transmitting the weightiest diagnosis to the caregiver 10, wherein the caregiver 10 may prescribe a prescription, therapy and further medical tests for the patient 10.

The microscope slide of a biological specimen 30 is prepared, according to procedures well known by those skilled in the art of the microscopy of biological specimens, and is inserted into a microscope 35. In some cases, a Wright/Giemsa stain is applied to differentiate nuclear and cytoplasmic morphology of red and white blood cells as well as parasites on blood smears. In what is popularly referred to as a “white blood cell differential count”, the white blood cell count is normal if the average number of white blood cells seen per 40× field averages between 2 and 7. Only five or more 40× objective fields are necessary if a consistent number of cells is seen. In one embodiment, the microscope 35 is of the paper layered Foldscope™ variety discussed above, where more than one image for electronic transmission may be sent to the remote computer and assembled as a one file to be viewed.

In one non-limiting embodiment, a camera 40 is assumed as an integral component to a tablet or a smartphone 45, such as the iPhone or iPad (each a Trademark of Apple, Inc.). In addition to transmitting 50 an image of the specimen 30, the caregiver 20, in one embodiment, also transmits patient data, such as an identification code, age, and other indicators relevant to a medical examination, as well as demographic information, such as location, ethnic grouping, and local conditions, such as diseases prevalent in the area. This type of information may be transmitted 50 as a text message.

The Internet cloud 55 server 60 contains one or more computers for receiving and sending between IP addresses or a phone link to transmit store the images of the patient specimens 25, as well as the relevant patient information and associated demographic information, and other servers as required for establishing a “social” network of the crowdsource volunteers 75 to participate in the diagnosis, as well as servers for carrying out the data processing associated with compiling the results of diagnoses, weighting the diagnosis as will be explained below, and forming a final diagnosis base on a statistic, such as a variance of a statistical distribution or a central tendency of a statistical distribution of diagnoses (also referred to as a mean diagnosis and in alternative embodiments as a median diagnosis and a mode diagnosis) for transmission to the caregiver 10. The three most common measures of central tendency are the mean (arithmetic average of the scores), the mode (the most frequently occurring score) and the median (the score that falls in the center of the distribution when scores are ordered from lowest to highest). In any statistical distribution, reference to parameters such as mean, median, mode and variance are well understood mathematical terms by those in the applied mathematical arts.

The server 60 can be any device having an appropriate processor, memory, and communications capability for receiving and transmitting the information identified above. The tablet or smartphones 45, 65 or the crowdsource volunteer's computing devices, to which the server 60 is connected over the network 55, can be, for example, one or more desktop computers, mobile computers, tablet computers, mobile devices (e.g., a smartphone or PDA), or any other devices having appropriate processor, memory, and communications capabilities. The network 55 can include, for example, any one or more of a personal area network (PAN), a local area network (LAN), a campus area network (CAN), a metropolitan area network (MAN), a wide area network (WAN), a broadband network (BBN), the Internet, and the like. Further, the network 55 can include, but is not limited to, any one or more of the following network topologies: a bus network, a star network, a ring network, a mesh network, a star-bus network, tree or hierarchical network.

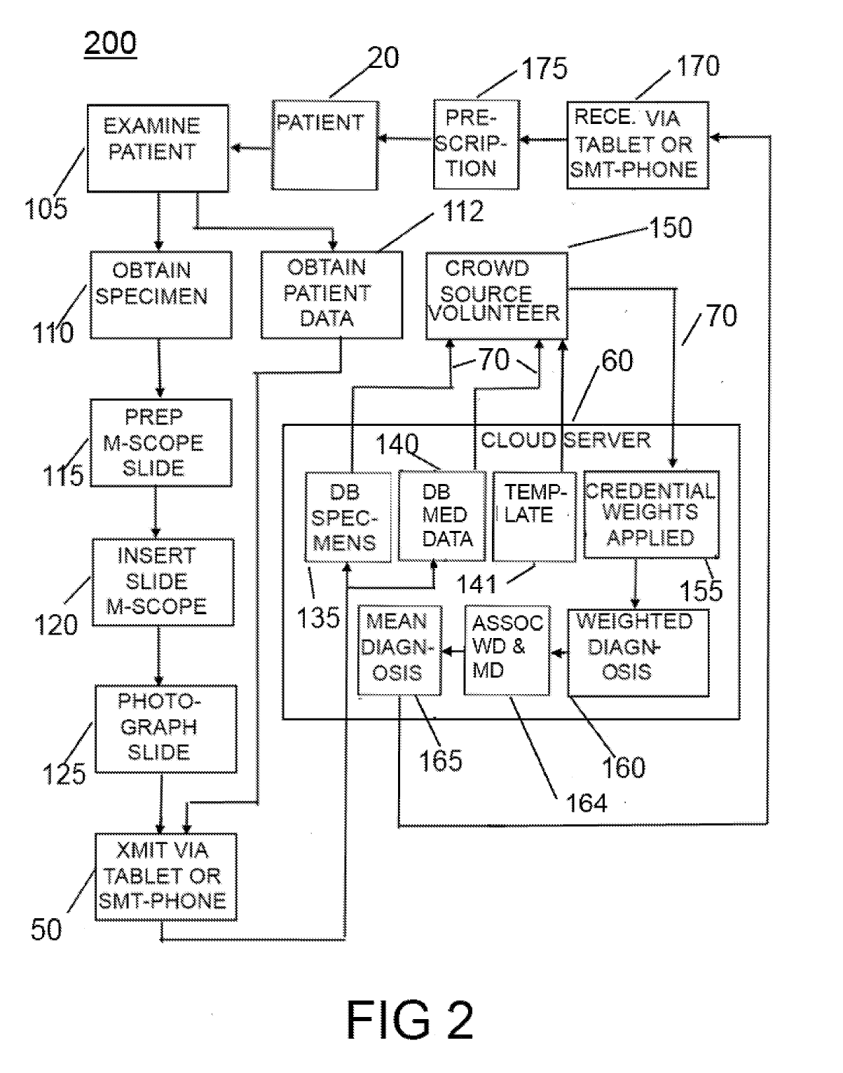

FIG. 2 is a flow chart of process 200 representing one embodiment of the present invention. The patient 20 is examined 105 by the caregiver 10, who obtains 110 a specimen 25, prepares 115 a microscope slide 30, inserts 120 the microscope slide 30 in a microscope, photographs 125 the microscope slide 30 and stores it in the tablet or smartphone 45. Additionally the caregiver 10 inputs into the tablet or smartphone 45, patient data 112, which includes the patient relevant information and demographic information. The Steps 125, 112 and 130, may be facilitated using an APP that is a self-contained program or piece of software designed to fulfill a particular purpose such as an application, especially as downloaded by a user to a mobile computing device.

The DATA is transmitted 130 for reception to cloud server 60, which administers the functions that communicate with one or more network connections for receiving data from mobile computing devices 45 over a network 55, e.g., a global computer communications network, such as the Internet, a wide area network, a metropolitan area network, a local area network, a terrestrial broadcast system, a cable network, a satellite network, a wireless network, or a telephone network, as well as portions or combinations of these and other types of networks. Other servers may be in communication with network 55 or may be in direct communication with other tablet or smartphones 45 or 65 from around the world in other locations. Server 60 is in persistent communication through the network 55, crowd source volunteer 150, tablets smartphones and computer terminals (not shown), or smartphones 45 or 65.

The image data of the specimen 25 is stored in any suitable database, such as database 135, and patient (Text) data 112 is stored in any suitable database, such as database 140, which includes the patient relevant information and demographic information. The databases are accessible for analysis and diagnosis by the crowdsource volunteer 150, who is one of many crowdsource volunteers 75. The communications between the volunteer 150 and the cloud server 60 applications may be facilitated using an APP that is a self-contained program or piece of software designed to fulfill a particular purpose such as an application, especially as downloaded by a user to a mobile computing device.

The process 200 performs the steps of forming the network of crowdsource volunteers 75 and collecting the opinions or diagnoses of at least two or more crowdsource volunteers 150, each of whom are referred to as a crowdsource volunteer 150, who select a diagnosis among possible diagnoses. In an alternative embodiment, the crowdsource volunteer 150 identifies a specimen as best fitting into a category. The choice of the category is then processed by the process 200, by executing the step of weighting the saliency 160 of each selected diagnosis, based upon a qualification of a crowdsource volunteer 150. For example, a novice to the process identifying a specimen as x, would result in a weight of 10 when stored, with the opined diagnosis, whereas a skilled volunteer 150, who also identified a specimen as x, would result in a weight of 100 when stored, with the opined diagnosis. Once all the weighted diagnoses are received, the process 200 sums the totals of selected diagnosis, according to one or more categories of candidate diagnoses, to form a probable diagnosis, referred to as a mean diagnosis 165, that reflects the most heavily weighted, which on a histogram would appear as the diagnosis having the highest relative frequently among candidate diagnoses.

The system 100 may also compile and store a library resident in a database to aid the crowdsource volunteer 150 by supplying templates of representative images of biological specimens, 141, as well as diagnostic hints, clues and statistics associated with past diagnoses.

The system 100 and process 200 may also form a differential diagnosis based on one or more of categorical, rank order and quantitative measurements. In each instance the diagnosis may be modified, or augmented by numerical value that represents the weighting of an opinion as explained above. The process 200 stores the number of times an occurrence of a diagnosis is selected by the crowdsource volunteers 150. For example, a nominal measure represents observations that are categorical, that is, observations that simply express differences in kind. The five major white blood cell types are an example of a nominal variable, where a cell may be classified into a category. This scale of measurement reflects differences in type only, without any indication of a quantitative difference. Simply stated the number of crowdsource volunteers 150 choosing one cell type (e.g., a monocyte versus a lymphocyte white blood cell type) over another are tallied. The one cell type most frequently chosen cell is associated with a specific diagnosis, which becomes the maximum occurring diagnostic choice.

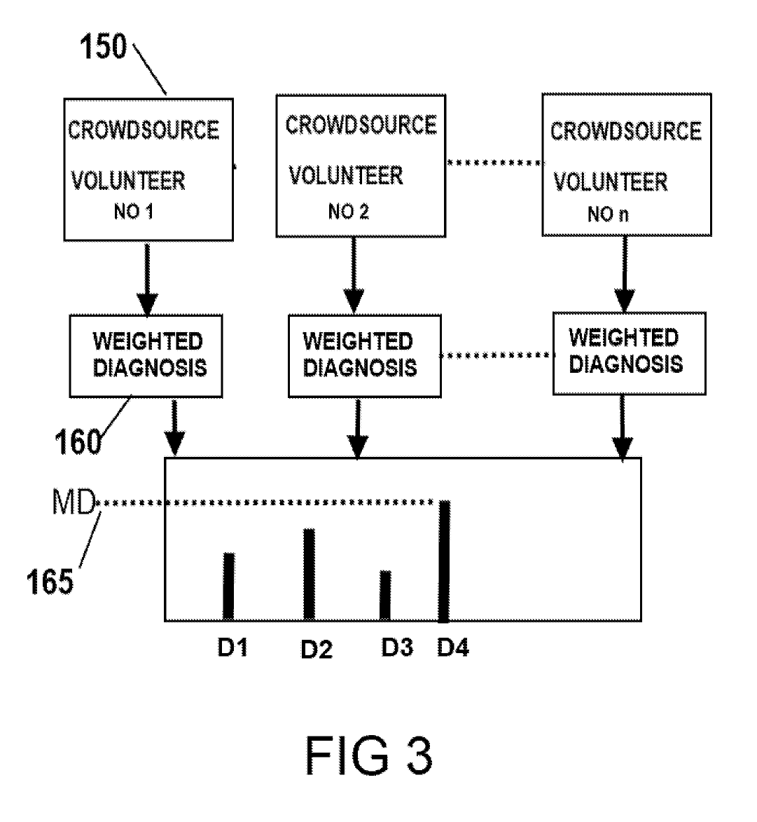

Likewise, process 200 in one non-limiting embodiment, may also form a differential diagnosis based on, by way of example, ordinal data, which builds on the nominal scale, adding the notion of ranked order. Here, differences reflect a quantitative variation such as that of a first, second and nth place choice. In this instance, one may be uncertain as to precisely what category the sample or a salient feature of the sample may represent, but can rank the samples based on a subjective probability. For example, assume that there is a 20% chance sample fits in to category monocyte and a 80% chance it fits into category lymphocyte. The cell type garnering the greatest likelihood based on percentages becomes the maximum occurring or most frequently occurring choice, which is associated with a specific diagnosis, which becomes the maximum occurring diagnostic choice. As shown in FIG. 3, alternatively, the nth place in sample identification with multiple rankings can be summed to determine the number of “votes,” based on the qualifications of the crowdsource volunteers 150, it receives.

Process 200 may also form a differential diagnosis based on an interval scale, which builds on the ordinal scale by adding a fixed unit of measurement between intervals. The interval scale builds on the ordinal scale by adding a fixed unit of measurement between intervals. There may for example be medical significance to the distance between the endoplasmic reticulum and the nuclear envelop in a eukaryotic cell. A difference between 3 and 6 microns is the same difference between 9 and 12 microns. For some observations, there may be valid medically scientific reasons to classify a feature of a specimen based on an interval scale.

Lastly, the ratio scale, builds on the interval scale by including the notion of a known absolute zero, meaning, the absence of the variable being measured. The amount of area of cytoplasm compared to a nucleus would be considered ratio. Because interval and ratio data can be added and subtracted, one may calculate a mean or average (a commonly used measure of central tendency) and standard deviations (a commonly used measure of variation). As shown in FIG. 3, such determinations resulting in categorical or quantitative measures result in a most frequently occurring statistic such as statistic D4, which is associated with a specific diagnosis, referred to above as the (a) identification of the specimen and optionally its salient attributes or (b) an analysis of the health status, such as a diagnosis of a specific disease, family of disease or clinical condition, and establishes the maximum occurring diagnostic choice 165.

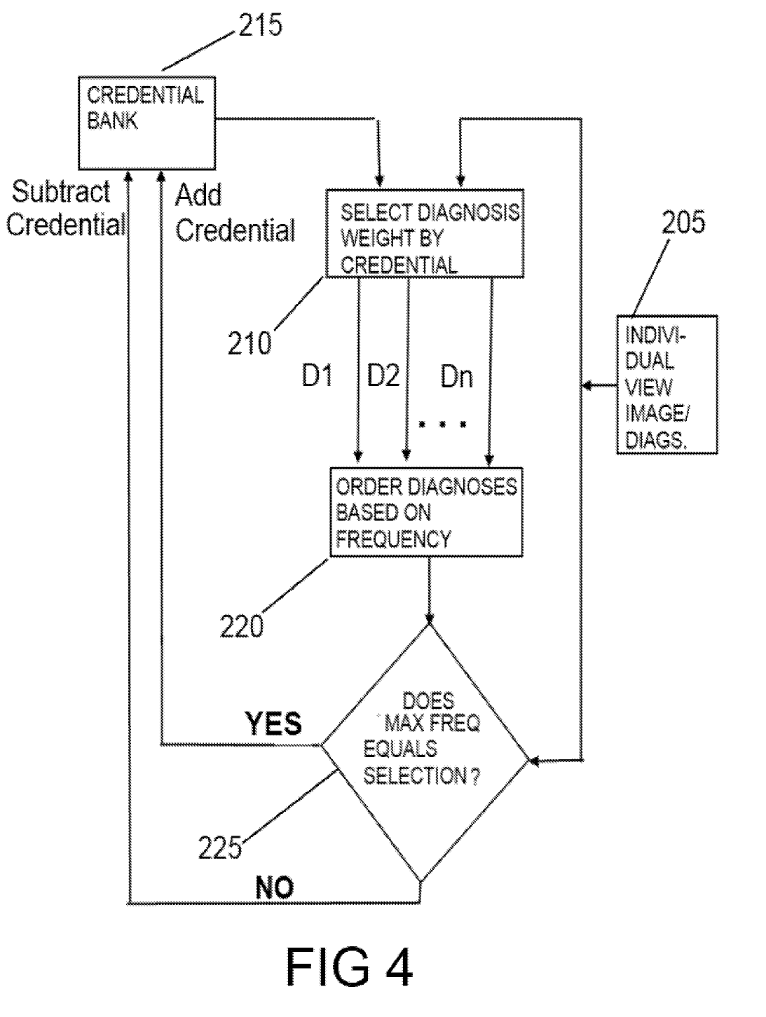

In one embodiment of the invention as shown in FIG. 4, a template database 141, stores images that resemble the one or more biological specimens that may be presented to the crowdsource volunteer 150, to assist in the diagnosis. In one embodiment a template of images is used where the volunteer is asked to force rank the specimen on a range from 1 to 10, the most likely to least likely the resemblance of the template image to the specimen 25. The pooled ranking from the crowdsource volunteers 75 may establish a mean ranking with a variance. The statistics, such as mean, variance, median and mode, may be used to establish the mean diagnosis 165.

With reference to FIG. 2 and FIG. 4, in an alternative embodiment of the invention, a diagnosis is determined by the crowdsource volunteer 150 and forwarded to the cloud server 60, where it is assigned a numerical weight designated as a “credential weights applied” 155. The numerical weight is used as a measure of the level of significance to accord the selected diagnosis, when compared to other crowdsource volunteers 75. The weight is determined as a function of a qualification of an individual crowdsource volunteer 150 that includes by way of example and not limitation, their education, training, experience, years in the field of the biological or medical arts and number of times the individual on prior occasions selected a diagnosis that fell into the category of the mean diagnosis 165. The “credential weight itself is determined by the process 200 executing the step of: calculating a qualification weight for the crowdsource volunteer 150 based on the crowdsource volunteer 150 identification of a prior specimen. The prior specimen for calculating a qualification weight may include a specimen based on a prior identification, but where the crowdsource volunteer 150 had not participated, and merely employs the prior specimen to establish its qualification for participating in subsequent process for an actual identification.

The server 60 contains a system for managing the directory of crowdsource volunteers 75, and information relevant to their participation, as by way of example and not limitation, their names, nationality, their addresses, phone numbers, passwords to gain access to the process 200, their base qualifications, e.g., education, training, experience, years in the field of the biological or medical arts and their updated qualification, i.e., the number of times the individual selects a diagnosis to form a probable diagnosis that falls into the category of the mean diagnosis 165.

Included in the process 200 management system is a window of time, within which the crowdsource volunteer 150 will be able to determine a diagnosis. When the window closes, the process 200 computes the mean diagnosis 165, by totaling the number of “votes” or the number of times the diagnosis was selected. For each distinct diagnosis proffered by a crowdsource volunteer 150, the process 200 applies the credential weights applied 155 pertaining to each crowdsource volunteer 150. A majority in favor of a diagnosis is determined to be the mean diagnosis 165, which is then, transmitted 170 to the caregiver 10, and with the option of a machine generated prescription 175 (which also may include a therapy or request for more DATA). In an alternate embodiment a median of the statistical distribution of crowdsource volunteers in favor of a diagnosis is determined to be the diagnosis 165. In yet another alternate embodiment a mode of the statistical distribution of crowdsource volunteers in favor of a diagnosis is determined to be the diagnosis 165.

FIG. 4 illustrates one embodiment of the credentialing of the crowdsource volunteer 150. A credential bank 215 contains a database of the base qualifications as modified by how well the crowdsource volunteer 150 performs relative to the majority decision (“relative qualification”). When a crowdsource volunteer 150 reviews the image and other medically relevant data, such as patient relevant information and demographic information, he or she renders a diagnosis by transmitting it to a process 210 that weighs, using the relative qualification, i.e., the selected diagnosis by the crowdsource volunteer 150. By way of example and not limitation, a novice to the art of biological specimen identification, who may have taken basic biology and a laboratory course at a university is awarded a credential weight of 10 units, therefor if the novice selects a diagnosis for example, of malaria, after viewing the biological image and accompanying information, the diagnosis is scored a 10. A pathologist with a 10 year experience in a U.S. hospital, is educated as medical doctor, may be awarded a credential of 100 units, and therefore their diagnosis is accorded a weight of 100.

Process 210 outputs the scores of the different diagnoses, referred to as weighted diagnosis 160 (see, FIG. 2), which orders the diagnoses on the basis of their frequency of occurrence, which when associated with a medical conditions 164, such as disease, is referred to as the mean diagnosis 165 (see, FIG. 2, FIG. 3). In one embodiment, the mean diagnosis 165 is compared to the diagnosis tendered by the crowdsource volunteer 150, in decision block 225, to determine if the crowdsourced volunteer 150 diagnosed the same illness as the mean diagnosis 165, indicating whether there exists an alignment of the diagnosis. If the crowdsource volunteer 150 is in alignment with the mean diagnosis 165, the crowdsource volunteer 150 credential is increased, the increase applied to a next subsequent effort to diagnose. By way of example, if it were previously credentialed with a weight of 10, it may be stepped up to 11, the next time the crowdsource volunteer 150 employs system 100. Likewise if the crowdsource volunteer 150 is not in alignment with the mean diagnosis 165, the crowdsource volunteer 150 credential is decreased in value. In this example, the individual's performance is credited for diagnoses that conform to the majority.

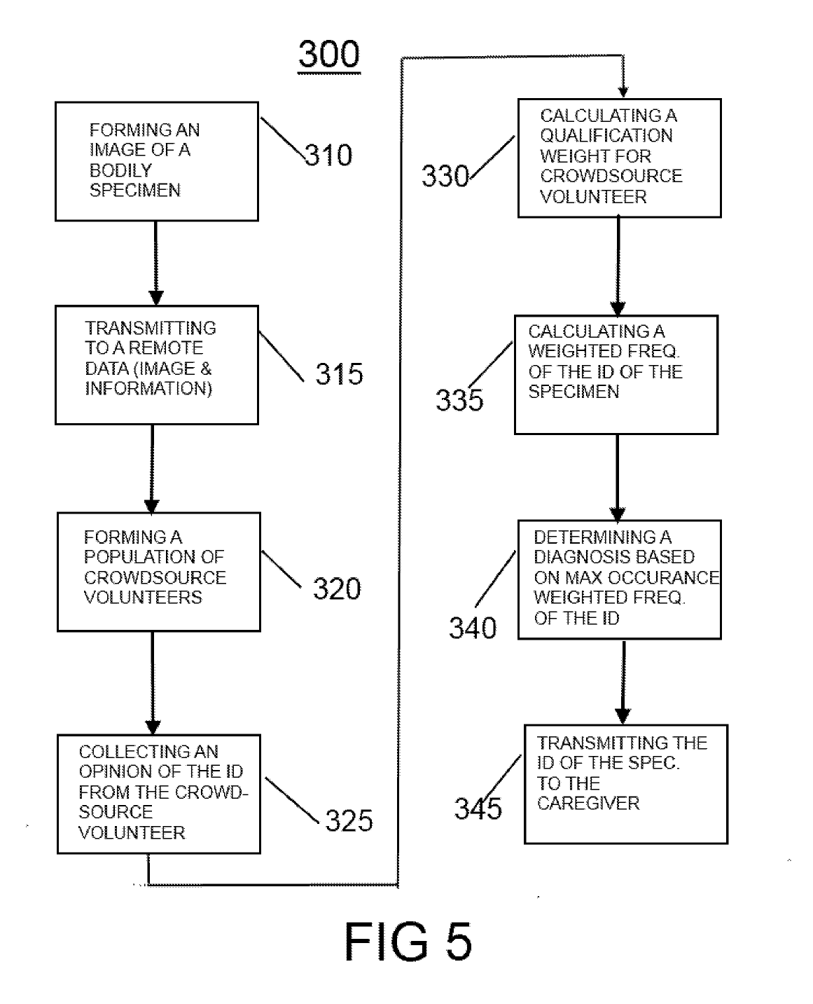

FIG. 5 shows a preferred embodiment of a computer-implemented method 300 for crowdsourcing a medical diagnosis comprising the steps of: forming an image of a bodily specimen from a microscope slide 310, which includes (see, FIG. 1 and FIG. 2): the patient 20, examined 105 by the caregiver 10, who obtains 110 a specimen 25, prepares 115 a microscope slide 30, inserts 120 the microscope slide 30 in a microscope, photographs 125 the microscope slide 30 and stores it in the tablet or smartphone 45. Process 300 performs the steps of transmitting 315 to a remote computer, the image and information related to the patient; forming a population 320 of crowdsource volunteers for an identification of the specimen; collecting an opinion 325 of the identification of the bodily specimen from a crowdsource volunteer; calculating a qualification weight 330 for the crowdsource volunteer based on the crowdsource volunteer identification of a prior specimen; calculating a weighted frequency 335 of the identification of the specimen by applying the qualification weight to the crowdsource volunteer identification of the specimen; determining a diagnosis 340 based on a maximum occurrence weighted frequency of the identification of the specimen; transmitting the identification of the specimen 345 to the caregiver, wherein the caregiver may prescribe one of a prescription drug, a therapy or a medical test.

Again with reference to FIG. 1, in one embodiment, this invention also provides for a system for crowdsourcing a medical diagnosis including the: a microscope 30 for forming an optical image of a bodily specimen 25 from a microscope slide 30, a digital acquisition device 40, such as a smartphone 45 for electronically capturing the optical image of the bodily specimen 25, a communication system 50, 55 for transmitting to a remote computer 60, data including, the electronic image and text information related to the patient, one or more computer storage devices, 135, 141 for storing the data, a computer 60 and software for connecting a population of crowdsource volunteers 75 for an identification of the specimen, a computer processor for: collecting an opinion of the identification of the bodily specimen from a crowdsource volunteer, forming a weighted frequency of the identification of the specimen by applying a qualification weight to the crowdsource volunteer identification of the specimen, forming a diagnosis based on a maximum occurrence weighted frequency of the identification of the specimen, transmitting the identification of the specimen to the caregiver.

Data storage devices (not shown), within which systems, application and communications programs as well as databases 135, 140, 141 may be stored, include a hard magnetic disk drive, optical storage units, CD-ROM drives, or flash memory. Data storage devices contains databases used in processing calculations, such as computing the mean diagnosis or the matching of a crowdsource volunteer and his or her credential weight, in accordance with the present invention. In one embodiment, database software creates and manages these databases. A controller (not shown) resident in the server CPU comprises a processor (not shown), such as one or more conventional microprocessors and one or more supplementary co-processors such as math co-processors. The processor is in communication with a communication ports through which the server 60 communicates with other devices such as other servers, user terminals or devices and the Internet 55. The communication port may include multiple communication channels for simultaneous communication with, for example, other processors, servers or client terminals. As stated, devices in communication with each other need not be continually transmitting to each other. On the contrary, such devices need only transmit to each other as necessary, may actually refrain from exchanging data most of the time, and may require several steps to be performed to establish a communication link between the devices. The processor also is in communication with the aforementioned data storage device. The data storage device may comprise an appropriate combination of magnetic, optical and/or semiconductor memory, and may include, for example, RAM, ROM, flash drive, an optical disc such as a compact disc and/or a hard disk or drive. The processor and the data storage device each may be, for example, located entirely within a single computer or other computing device; or connected to each other by a communication medium, such as a USB port, serial port cable, a coaxial cable, a Ethernet type cable, a telephone line, a radio frequency transceiver or other similar wireless or wireline medium or combination of the foregoing. The data storage device may store, for example, (i) a program (e.g., computer program code and/or a computer program product adapted to direct the processor in accordance with the present invention, and particularly in accordance with the system and processes described in FIGS. 1, 2, 3 and 4. The instructions of the program may be read into a main memory of the processor from a computer-readable medium other than the data storage device, such as from a ROM or from a RAM. While execution of sequences of instructions in the program causes the processor to perform the process steps described herein, hard-wired circuitry may be used in place of, or in combination with, software instructions for implementation of the processes of the present invention. Thus, embodiments of the present invention are not limited to any specific combination of hardware and software.

The term “computer-readable medium” as used herein refers to any medium that provides or participates in providing instructions to the processor of the computing device (or any other processor of a device described herein) for execution and more particularly for executing the system and processes indicated in FIGS. 2, 3, and 4. More particularly, the process 200 may exist as a non-transitory computer readable medium having program code stored thereon, the program code being executable by a processor to cause the processor to perform operations, shown in FIGS. 2, 3 and 4. Such a medium may take many forms, including but not limited to, non-volatile media, volatile media, and transmission media. Non-volatile media include, for example, optical or magnetic disks, such as memory. Volatile media include dynamic random access memory (DRAM), which typically constitutes the main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM or EEPROM (electronically erasable programmable read-only memory), a FLASH-EEPROM, any other memory chip or cartridge, a carrier wave as described hereinafter, or any other medium from which a computer can read.

Various forms of computer readable media may be involved in carrying one or more sequences of one or more instructions to the processor (or any other processor of a device described herein) for creating, executing and porting the portable software. For example, the instructions may initially be borne on a magnetic disk of a remote computer. The remote computer can load the instructions into its dynamic memory and send the instructions over an Ethernet connection, cable line, or even telephone line using a modem. A communications device local to a computing device (or, e.g., a server) can receive the data on the respective communications line and place the data on a system bus for the processor.

While the present invention has been described with reference to the illustrative embodiments, this description is not intended to be construed in a limiting sense. Various modifications of the illustrative embodiments, as well as other embodiments of the invention, will be apparent to those skilled in the art on reference to this description. It is expressly intended that all combinations of those elements that perform substantially the same function in substantially the same way to achieve the same results are within the scope of the invention. Substitutions of elements from one described embodiment to another are also fully intended and contemplated. It is therefore contemplated that the appended claims will cover any such modifications or embodiments as fall within the true scope of the invention.

1. A process for remotely identifying a biological specimen for determining a medical diagnosis comprising: (1) assembling a print-and-fold microscope; (2) forming an image through the print-and-fold microscope from a microscope slide containing a bodily specimen of a patient; (3) electronically capturing the image; (4) transmitting the image and information related to the patient to a remote processor for storage; (5) using program code executed by the processor for connecting a first database having the image and information stored thereon to one or more devices for identification of the specimen based on morphological characteristics and microbial invasion(s); (6) using program code executed by a processor for collecting one or more diagnostic opinion of the identification of morphological characteristics and microbial invasion(s) of the bodily specimen which opinions are quantified using one of a nominal scale, ordinal scale, or ratio scale, which is stored in a second database; (7) using program code executed by a processor for calculating a qualification weight of each diagnostic opinion stored in a third database, based on each identification of a prior specimen when compared, using program code executed by a processor, to a standard; (8) using program code executed by a processor for calculating a weighted frequency of the identification of the specimen by applying the qualification weight to each identification stored in a fourth database; (9) weighting the saliency of each selected diagnosis based on (a) a maximum occurrence, (b) a median occurrence or (c) a mode occurrence of the identification of the specimen; (10) storing the diagnosis of the specimen in a fifth database; and (11) transmitting to a caregiver the identification of the specimen and diagnosis and one or more of a prescription drug, a therapy or medical test to one of a smartphone or computer having a display.

2. The method of claim 1, wherein the qualification of a crowdsource volunteer includes one or more of their education, training, experience, time spent in the field of the biological or medical arts and number of times the individual selects a identification of the specimen that falls into a maximum occurring diagnosis selected by the population of crowdsource volunteers.

3. The method of claim 1, wherein the qualification of the crowdsource volunteer is determined by a number of times the crowdsource volunteer selected an identification of the specimen that fell into the category of the maximum occurrence among other selected diagnoses on prior occasions.

4. (canceled)

5. The method of claim 1, further including the step of: compiling one or more statistics associated with a white blood cell differential count.

6. The method of claim 1, further including the step of: computing a mean diagnosis, by totaling the diagnosis based on a maximum occurrence weighted frequency where the identification was selected.

7. The method of claim 1, further including the step of awarding a credential weight to the crowdsource volunteer based on a diagnosis that conforms to the maximum occurrence among other candidate diagnoses.

8. The method of claim 1 wherein, the opinion of the identification of the bodily specimen from a crowdsource volunteer includes an opinion on a diagnosis among two or more possible diagnoses.

9. The method of claim 1 wherein, determining a diagnosis based on one of weighted frequency includes a variance of a statistical distribution of the identification of the specimen.

10. A system for remotely identifying a biological specimen for determining a medical diagnosis comprising: (1) a print-and-fold microscope for forming an optical image of a bodily specimen from a microscope slide; (2) a digital acquisition device for electronically capturing an optical image of the bodily specimen formed through the microscope; (3) a communication system for transmitting to a remote computer, data including the electronic image and text information related to the patient; (4) a computer storage device for storing the data; (5) a computer system and software for connecting a population of crowdsource volunteers stored in a first database for an identification of the specimen quantified using one of a nominal scale, ordinal scale, or ratio scale, which is stored in a second database; (6) a computer processor for: (i) collecting an opinion of the identification of the bodily specimen stored in a second database, (ii) calculating a qualification weight of each diagnostic opinion stored in a third database based on each identification of a prior specimen when compared, using program code executed by a processor, to a standard, (iii) calculating a weighted frequency of the identification of the specimen by applying the qualification weight to each identification stored in a fourth database, (iv) weighting the saliency of each selected diagnosis based on frequency of (a) a maximum occurrence, (b) a median occurrence or (c) a mode occurrence of the identification of the specimen, transmitting the identification of the specimen and a diagnosis and one or more of a prescription drug, a therapy or medical test to one of a smartphone or computer having a display thereon.

11. The system of claim 10, wherein the computer processor calculates an identification of the specimen based on at least one quantitative parameter.

12. The system of claim 10, wherein the computer processor calculates the qualification of the crowdsource volunteer utilizing a number of times the crowdsource volunteer selected an identification of the specimen that fell into the category of the maximum occurrence among other selected diagnoses on prior occasions.

13. (canceled)

14. The system of claim 10, wherein the computer processor compiles statistics associated with the at least one of suggested diagnosis.

15. The system of claim 10, wherein the computer processor calculates the mean diagnosis, by totaling the number of times the weighted diagnosis was selected.

16. The system of claim 10, wherein the computer processor calculates awarding to the crowdsource volunteer a credential weight based on a diagnosis that conforms to at least one quantitative parameter.

17. The system of claim 10, wherein the computer processor retrieves a template database of images that resembles the specimen that may be presented to the crowdsource volunteer.

18. The system of claim 10, wherein the computer processor queries the crowdsource volunteer to force rank the specimen on a range to indicate a most likely to least likely resemblance of the template to the specimen.

19. (canceled)

20. A process for a medical diagnosis comprising: (1) assembling a print-and-fold microscope; (2) forming an image through the print-and-fold microscope from a microscope slide containing a bodily specimen of a patient; (3) electronically capturing the image; (4) transmitting the image and information related to the patient to a remote processor for storage; (5) using program code executed by the processor for connecting a first database having the image and information stored thereon to one or more devices for identification of the specimen based on morphological characteristics and microbial invasion(s); (6) using program code executed by a processor for collecting one or more identifications of morphological characteristics and microbial invasion(s) of the bodily specimen which are quantified using one of a nominal scale, ordinal scale, or ratio scale, which is stored in a second database; (7) using program code executed by a processor for calculating a qualification weight of each identification stored in a third database, based on identification of a prior specimen when compared, using program code executed by a processor, to a standard; (8) using program code executed by a processor for calculating a weighted frequency of the identification of the specimen by applying the qualification weight to each identification stored in a fourth database; (9) weighting the saliency of each identification stored in the fourth database based on one of (a) a maximum occurrence, (b) a median occurrence or (c) a mode occurrence of the identification of the specimen; (10) storing the diagnosis of the specimen in a fifth database; and (11) the identification of the specimen and diagnosis and one or more of a prescription drug, a therapy or medical test to one of a smartphone or computer having a display.
